(19) United States
(12) Patent Application Publication
(10) Pub. No.: US 2026/0278502 A1
(43) Pub. Date: Sep. 17, 2026

(54) AUTOMATIC AND INTERACTIVE ARTIFICIAL INTELLIGENCE AGENT FLOW GENERATOR USING LARGE LANGUAGE MODEL PROMPTS

(71) Applicant: eBay Inc., San Jose, CA (US)

(72) Inventors: Wenyu Dong, Shanghai (CN); Jie Gao, Shanghai (CN); Yanjie Wang, Shanghai (CN); Zitao Zhang, Shanghai (CN); Yicheng Gong, Shanghai (CN); Lei Chen, Shanghai (CN); Yang Zhao, Shanghai (CN); Yinan Shan, Shanghai (CN)

(21) Appl. No.: 19/076,299

(22) Filed: Mar. 11, 2025

(51) Int. Cl. G06Q 10/0631

(52) U.S. Cl. CPC G06Q 10/06316

(57) ABSTRACT

Some aspects relate to technologies for an artificial intelligence (AI) agent flow generator that leverages large language model prompts to build AI agent workflows. In accordance with some aspects, an input is received at a prompt. The input requests the AI agent flow generator to create a workflow comprising one or more tasks for an application to execute. A large language model interprets the input into machine readable format to identity and retrieve a template from a flow template library. The AI agent flow generator generates domain specific language (DSL) corresponding to output of a ReAct agent and/or the template and an application programming interface call that causes the application to execute the DSL. The AI agent flow generator may provide a DSL file for the generated DSL to the application, causing the application to execute the DSL.

### BACKGROUND

Low-code and no-code platforms enable users, often with minimal technical knowledge and without coding experience, to build simple artificial intelligence (AI) agent workflows using visual interfaces. Although these platforms can build simple agent workflows, they are unable to build complex workflows. For example, these platforms are inadequate for workflows with multiple steps, involving multiple scenarios, and handling data details. Moreover, complex manual operations require consulting documentation and require a high level of prior knowledge to build a flow that meets the requirements.

### SUMMARY

Some aspects of the present technology relate to, among other things, an AI agent flow generator that leverages large language model (LLM) prompts to build AI agent workflows. In this way, complex flows can be created through simple conversation or voice inputs and dynamically adjusted in real-time. To do so, an input is received at a prompt. The input requests the AI agent flow generator to create a workflow comprising one or more tasks for an application to execute. A large language model interprets the request to machine readable format to identity and retrieve a template from a flow template library. The AI agent flow generator generates domain specific language (DSL) corresponding to output of a ReAct agent and/or the template and an application programming interface call that causes the application to execute the DSL. In some aspects, the AI agent flow generator provides a DSL file for the generated DSL, causing the application to execute the DSL.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is block diagram illustrating an example method for creating an AI agent workflow, in accordance with some implementations of the present disclosure;

FIG. 3 is block diagram illustrating another example method for adjusting an AI agent workflow, in accordance with some implementations of the present disclosure;

FIG. 4 is an example user interface, in accordance with some implementations of the present disclosure;

FIG. 5 is an example user interface, in accordance with some implementations of the present disclosure;

FIG. 6 is an example method for utilizing an agent flow generator to create a workflow, in accordance with some implementations of the present disclosure; and

FIG. 7 is a block diagram of an exemplary computing environment suitable for use in implementations of the present disclosure.

### DETAILED DESCRIPTION

There are a number of drawbacks to existing software development approaches, particularly with respect to AI agent workflows. For instance, manual AI agent workflow generation, while offering complete control and flexibility, has several shortcomings. It can be time-consuming and prone to human error, leading to bugs, inefficiencies, and inconsistencies in the workflow. Writing complex workflows from scratch requires significant expertise and effort, often resulting in slower development cycles and higher costs. Additionally, maintaining and updating manually workflows can become cumbersome, especially in complex scenarios and where real-time adjustments are needed. The lack of automation to create complex workflows that can be dynamically adjusted also limits scalability and may hinder rapid innovation in fast-paced environments.

No-code/low-code development can be seen as part of a broader trend towards democratizing application development, making it more accessible to a wider range of people, including those with limited coding expertise. No-code/low-code development platforms offer a simplified environment for creating AI agent workflows, but they come with several drawbacks, notably, limited customization and flexibility, overhead with complex logic, learning curve, and inability to make real-time adjustments. While no-code/low-code platforms can significantly speed up the development process and reduce the need for specialized coding knowledge, they may not be suitable for all types of projects, especially those requiring complex, highly customized, or unique solutions.

With the more recent advent of generative AI and coder LLMs, a current trend is to generate workflows through a manual drag and drop process. While efficient and time-saving, generative AI code development has several shortcomings. For instance, this approach is often limited to generating simple AI agent workflows. AI-generated code can lack the deep contextual understanding needed for complex or domain-specific problems, leading to incorrect or suboptimal solutions. It may also introduce subtle bugs or security vulnerabilities, especially when handling edge cases or nuanced requirements. The generative AI model could also generate simple workflows that work but cannot handle complex tasks or real-time adjustments. Additionally, AI models rely on the quality of their training data, which can result in outdated or biased workflow suggestions if the data is incomplete or flawed.

Moreover, the amount of back and forth required between the developer and the generative AI model to arrive at an acceptable workflow often results in the consumption of an unnecessary quantity of computing resources (e.g., I/O costs, network bandwidth usage, throughput, memory consumption, CPU/GPU usage, etc.). For instance, a developer may connect different components, such as prompts, language models, and data sources, causing the generative AI model to generate a workflow, which is presented to the developer. The developer reviews the workflow from the generative AI model and connects additional components, prompts, language models, and data sources to refine the code, causing the generative AI model to generate a new output. The back and forth process of manually dragging and dropping components, prompts, language models, and data sources and generating workflows by the generative AI model continues until the developer decides the generated workflow is sufficient or otherwise decides to manually edit the workflow. Given the unstructured nature of this process, the number of times this back and forth occurs can be extensive.

Each iteration of this conventional use of generative AI involves consumption of computer resources (e.g., bandwidth, memory, CPU/GPU usage), as well as puts wear and tear on physical computer components. For instance, repetitive iterations adversely affect computer network communications, increasing network bandwidth usage and latency. Additionally, the repetitive inputs from the developer and code generation by the generative AI model increase memory usage, CPU/GPU usage, and storage device I/O (e.g., excess physical read/write head movements on non-volatile disk) because each time a developer connects components, prompts, language models, and data sources, the computing system often has to reach out to the storage device to perform a read or write operation (which is time consuming, error prone, and can eventually wear on components, such as a read/write head) and consume processor and memory resources in executing the generative AI to generate code.

Aspects of the technology described herein provide a number of improvements over existing software development and improve the functioning of the computer itself in light of these shortcomings in current software development approaches by providing a solution that creates complex flows through simple conversations or voice inputs, with the ability to dynamically make real-time adjustments. This eliminates the need for extensive knowledge of flow operations and significantly reduces consumption of computing resources.

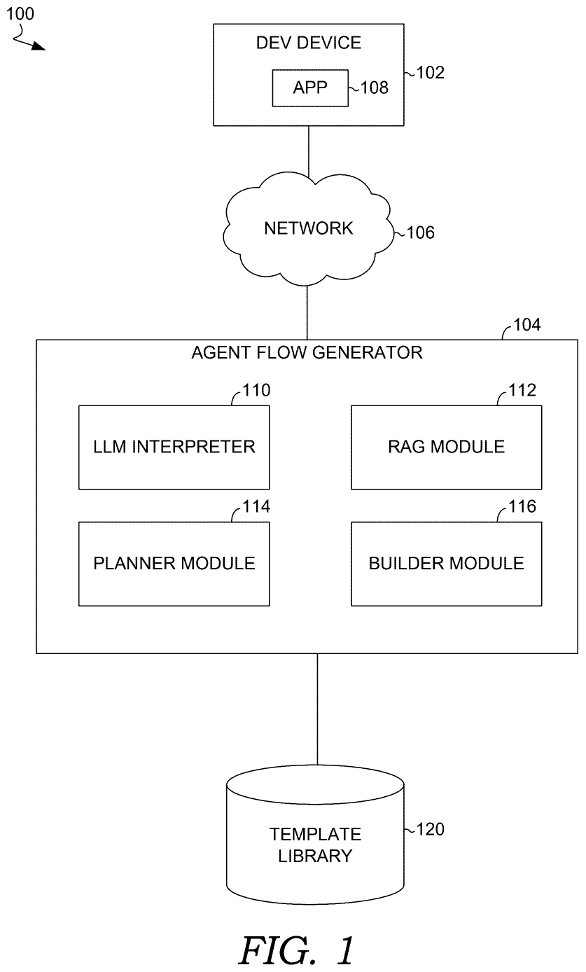

With reference now to the drawings, FIG. 1 is a block diagram illustrating an exemplary system 100 for an automatic and interactive AI flow generator using LLM prompts, in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

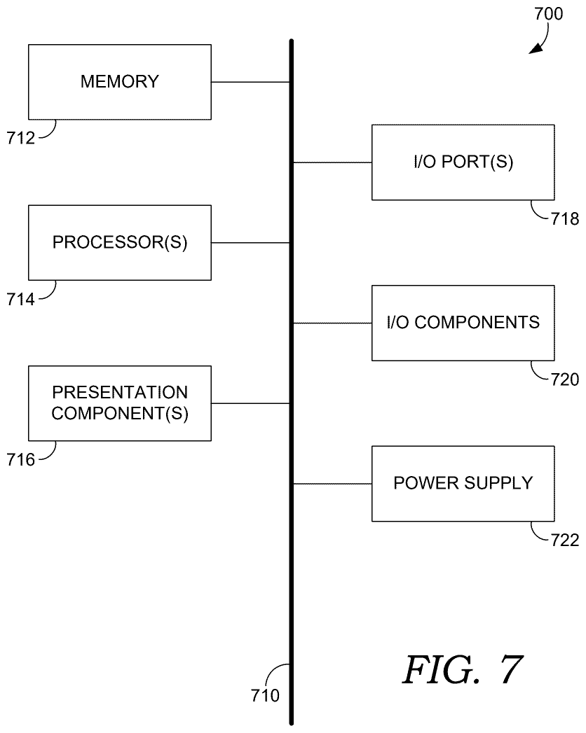

The system 100 is an example of a suitable architecture for implementing certain aspects of the present disclosure. Among other components not shown, the system 100 includes a developer device 102 and an agent flow generator 104. Each of the developer device 102 and the agent flow generator 104 shown in FIG. 1 can comprise one or more computer devices, such as the computing device 700 of FIG. 7, discussed below. As shown in FIG. 1, the developer device 102 and the agent flow generator 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of developer devices and servers can be employed within the system 100 within the scope of the present technology. Each can comprise a single device or multiple devices cooperating in a distributed environment. For instance, the agent flow generator 104 could be provided by multiple server devices collectively providing the functionality of the agent flow generator 104 as described herein. Additionally, other components not shown can also be included within the network environment.

The developer device 102 can be a client device on the client-side of operating environment 100, while the agent flow generator 104 can be on the server-side of operating environment 100. The agent flow generator 104 can comprise server-side software designed to work in conjunction with client-side software on the developer device 102 so as to implement any combination of the features and functionalities discussed in the present disclosure. For instance, the developer device 102 can include an application 108 for interacting with the agent flow generator 104. In some aspects, the application 108 can be, for instance, a web browser or a dedicated application for providing functions, such as those described herein. This division of operating environment 100 is provided to illustrate one example of a suitable environment, and there is no requirement for each implementation that any combination of the developer device 102 and the agent flow generator 104 remain as separate entities. While the operating environment 100 illustrates a configuration in a networked environment with a separate developer device and agent flow generator, it should be understood that other configurations can be employed in which components are combined. For instance, in some configurations, a developer device can provide some or all capabilities described in conjunction with the agent flow generator.

The developer device 102 can comprise any type of computing device capable of use by a user. For example, in one aspect, the developer device can be the type of computing device 700 described in relation to FIG. 7 herein. By way of example and not limitation, the developer device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user, such as a software developer, can be associated with the developer device 102 and can interact with the agent flow generator 104 via the developer device 102.

The agent flow generator 104 provides a platform for creating complex flows through simple conversations or voice inputs, with the ability to dynamically make real-time adjustments. As shown in FIG. 1, the agent flow generator 104 includes an LLM interpreter 110, a Retrieval-Augmented Generation (RAG) module 112, a planner module 114, and a builder module 116. The modules of the agent flow generator 104 can be in addition to other modules that provide further additional functions beyond the features described herein. The agent flow generator 104 can be implemented using one or more server devices, one or more platforms with corresponding application programming interfaces, cloud infrastructure, and the like. While the agent flow generator 104 is shown separate from the developer device 102 in the configuration of FIG. 1, it should be understood that in other configurations, some or all of the functions of the agent flow generator 104 can be provided on the developer device 102.

In one aspect, the functions performed by modules of the agent flow generator 104 are associated with one or more applications, services, or routines. In particular, such applications, services, or routines can operate on one or more developer devices, servers, can be distributed across one or more developer devices and servers, or be implemented in the cloud. Moreover, in some aspects, these modules of the agent flow generator 104 can be distributed across a network, including one or more servers and client devices, in the cloud, and/or can reside on a developer device. Moreover, these modules, functions performed by these modules, or services carried out by these modules can be implemented at appropriate abstraction layer(s) such as the operating system layer, application layer, hardware layer, etc., of the computing system(s). Alternatively, or in addition, the functionality of these modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific modules shown in example system 100, it is contemplated that in some aspects, functionality of these modules can be shared or distributed across other modules.

In aspects, the LLM interpreter 110 provides an interface between the developer device 102 and the agent flow generator 104. Generally, the LLM interpreter 110 interprets natural language input from a user and compiles it into machine friendly formats. Moreover, the LLM interpreter 110 ensures that user requirements, whether simple or complex, are accurately understood for downstream processing.

In aspects, the RAG module 112 is responsible for searching the template library 120 to find relevant results. The template library 120 may contain a marketplace of predefined, high-quality flow templates (for recommendation or reference), or selectable sub-tool modules for flow usages (e.g., code-execution, API-calls). Accordingly, the RAG module 112 ensures that the most fitting results are retrieved based on the requirements.

In aspects, the planner module 114 handles complex task planning by breaking down user requirements into smaller, manageable sub-task chains. The planner module 114 generates a directed flow diagram corresponding to the sub-tasks. For each individual sub-task, the planner module 114 creates detailed implementation sub-task flow that can more readily be consumed downstream.

In aspects, builder module 116, leverages a ReAct agent to generate a detailed execution plan for individual sub-tasks within the flow as identified by the planner module 114. The builder module 116 integrates the reasoning capability of LLM to loop through thought-action-observation cycles repeatedly to achieve the expected sub-task output. The builder module 116 summarizes the resulting chain as an action flow. The builder module 116 further aggregates multiple sub-task flows into a final flow that can be represented in DSL.

In some aspects, the agent flow generator 104 leverages voice control technologies, including automatic speech recognition (ASR), natural language processing (NLP), and machine learning-driven personalization, to create an intuitive, hands-free interaction environment. By employing advanced ASR algorithms, the agent flow generator 104 is able to capture and transcribe spoken commands with high accuracy, even in environments with background noise or multiple speakers.

Frameworks such as OpenAI's WHISPER for speech-to-text conversion may be utilized, enabling the agent flow generator 104 to decode user intent efficiently, interpret commands accurately, and adjust workflows, without the need for manual inputs. Further, voice recognition may be enhanced by machine learning algorithms that adapt to speech patterns of the user, improving with each interaction to offer increasingly personalized responses and seamless integration into daily operations.

In some aspects, the agent flow generator 104 includes real-time speech processing capabilities that enable it to interpret, process, and respond to commands in real-time, ensuring that workflow adjustments can happen instantly. Utilizing low-latency streaming architectures, the agent flow generator 104 processes voice input as it is received, reducing delays and creating a responsive experience for the user. This real-time capability is further enhanced by edge computing and speech synthesis technologies, which allow for rapid, on-device processing of commands to minimize lag and improve responsiveness, even in environments with limited connectivity.

In some aspects, agent flow generator 104 leverages transformer-based language models (e.g., GPT or BERT variants) that can be fine-tuned for quick speech processing, enabling agent flow generator 104 to comprehend complex instructions immediately and make relevant adjustments. In addition, text-to-speech (TTS) engines (e.g., Tacotron 2 or WaveNet) enable the agent flow generator 104 to respond in a natural and conversational tone, creating a more engaging and human-like experience.

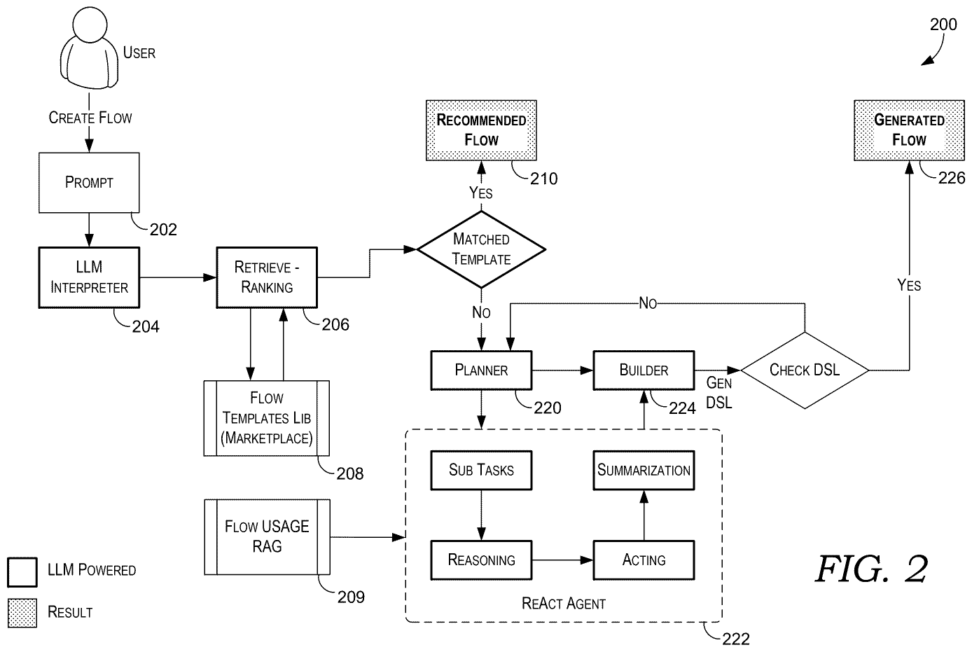

In practice, and turning now to FIG. 2, a block diagram illustrating an example method 200 is provided, in accordance with some implementations of the present disclosure. In example method 200, a user provides an input (i.e., a prompt) to the agent flow generator. By way of example, the user initially prompts 202 the agent flow generator to create an AI agent workflow that consists of the following steps: 1) query a database for top ranking transactions; 2) determine whether the top ranking transactions have a concentration effect; and 3) for each transaction check if account takeover (ATO) cases exist.

After being prompted, the LLM interpreter 204 interprets the prompt and compiles it into machine friendly formats. Next, the RAG module 206 searches the template library 208 to find results relevant to the prompt. As described, the template library 120 comprises flow templates (for recommendation or reference) or selectable sub-tool modules for flow usages (e.g., code-execution, API-calls).

If the RAG module 206 identifies a template that matches the prompt, the template can be utilized as the recommended flow 210. On the other hand, if the template does not match the prompt, the planner module 220 breaks down the user requirements into smaller, manageable sub-task chains. In this example, the planner module 220 may break the prompt into the three individual steps. Next, the planner module 220 generates a directed flow diagram corresponding to the sub-tasks.

The builder module 224 leverages the ReAct agent 222 to generate a detailed execution plan for individual sub-tasks within the flow as identified by the planner module 220. The builder module 224 integrates the reasoning capability of LLM and causes the ReAct agent 222 to reason, act, and summarize each of the sub-tasks. In some aspects, the flow usage RAG 209 is used as a reference of how to correctly apply predefined components to complete the sub-tasks. The flow usage RAG 209 may include names, descriptions, and usage documents for each of the predefined components. The builder module 224 summarizes the resulting chain as an action flow, aggregates multiple sub-task flows into a final flow, and generates the DSL corresponding to the final flow. If the DSL matches the requirements of the user, it is utilized as the generated flow 226. If the DSL does not match the requirements of the user, the process begins again at the planner module 220.

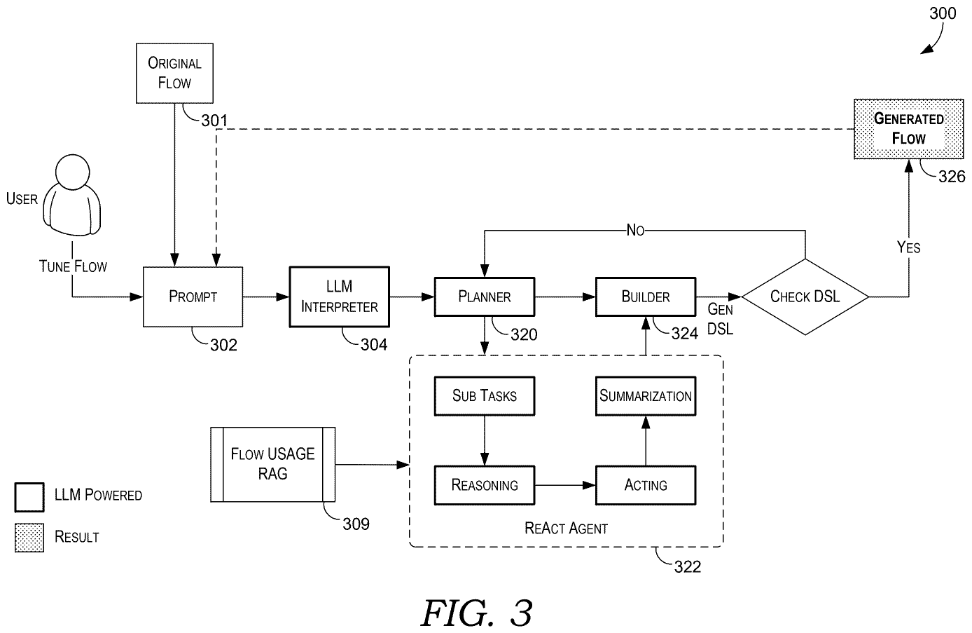

In FIG. 3, a block diagram illustrating another example method 300 is provided, in accordance with some implementations of the present disclosure. In example method 300, the original flow 301 already exists and the user provides an input (i.e., a prompt) to the agent flow generator. By way of example, the user initially prompts 302 the agent flow generator to adjust the original AI agent workflow that consists of the following steps: 1) add a block to the end to render a chart for the result; and 2) enable the user to select the chart type including bar chart, pie chart, etc.

After being prompted, the LLM interpreter 304 interprets the prompt and compiles it into machine friendly formats. The planner module 320 breaks down the user requirements into smaller, manageable sub-task chains. In this example, the planner module 320 may break the prompt into the two individual steps identified by the user in the prompt. Next, the planner module 320 generates a directed flow diagram corresponding to the sub-tasks.

The builder module 324 leverages the ReAct agent 322 to generate a detailed execution plan for individual sub-tasks within the flow as identified by the planner module 320. The builder module 324 integrates the reasoning capability of LLM and causes the ReAct agent 322 to reason, act, and summarize each of the sub-tasks. In some aspects, the flow usage RAG 309 is used as a reference of how to correctly apply predefined components to complete the sub-tasks. The flow usage RAG 309 may include names, descriptions, and usage documents for each of the predefined components. The builder module 324 summarizes the resulting chain as an action flow, aggregates multiple sub-task flows into a final flow, and generates the DSL corresponding to the final flow. If the DSL matches the requirements of the user, it is utilized as the generated flow 326. If the DSL does not match the requirements of the user, the process begins again at the planner module 320.

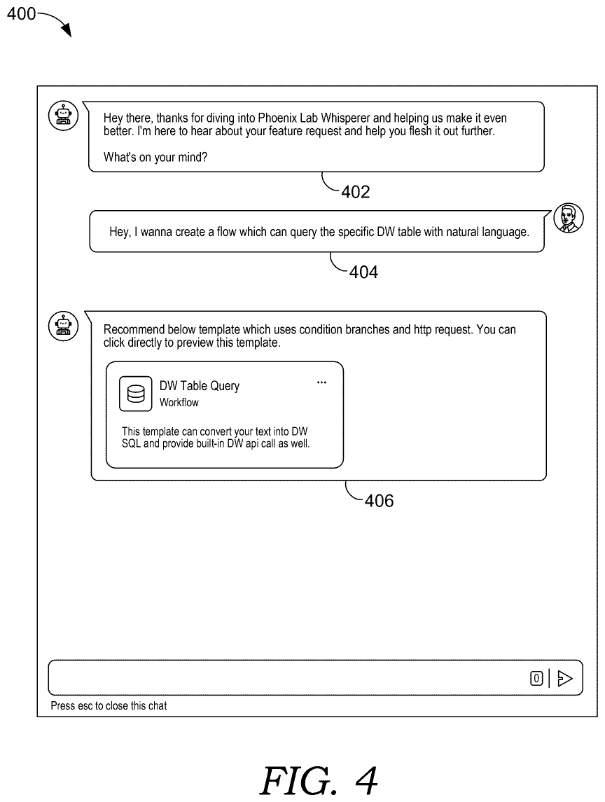

By way of illustration, FIG. 4 is an example user interface 400, in accordance with some implementations of the present disclosure. As shown, the agent flow generator enables a beginner user that may be unfamiliar with AI agent workflows to utilize the agent flow generator to build an AI agent workflow based on the most suitable predefined case or template. For example, the agent flow generator prompts 402 the user to identify a feature request for a workflow. The user may respond 404 in natural language asking the agent flow generator to query a specific database table. Agent flow generator searches for an existing template and responds to the user by providing a recommended template 406. Agent flow generator also enables the user to select and preview the workflow. By selecting the template, the natural language prompt of the user can be converted into SQL or some other query language. Moreover, the agent flow generator may provide a built-in API call allowing, or in some cases, causing, an application to execute the workflow.

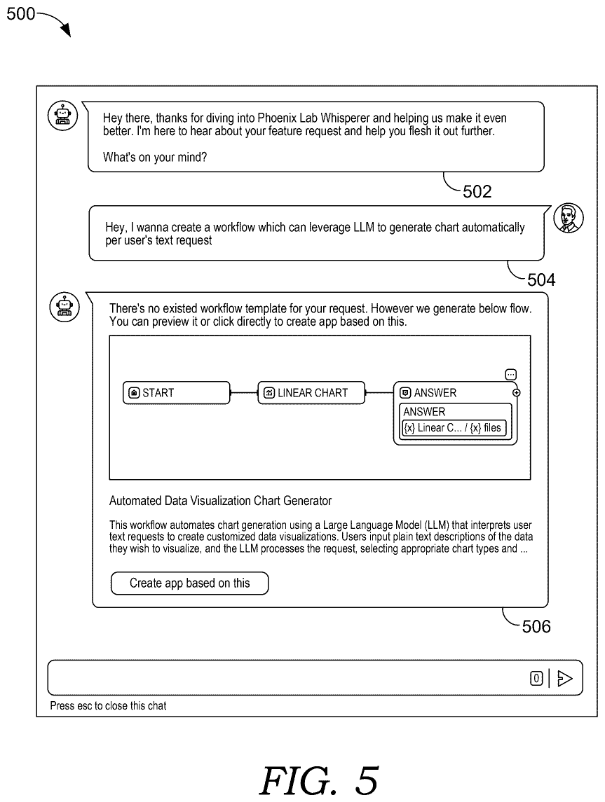

In another example illustration, FIG. 5 is an example user interface 500, in accordance with some implementations of the present disclosure. As shown, for users with more experience, agent flow generator provides the ability to create customized LLM agent flows directly from the user's description. Unlike the example shown in FIG. 4, a user can describe more complex and tailored needs, and the system will generate a custom flow that meets the user's specific requirements. For example, the agent flow generator prompts 502 the user to identify a feature request for a workflow. The user may respond 504 in natural language asking the agent flow generator to create a workflow that leverages LLM to generate a chart automatically based on a user's text request. Agent flow generator may search for an existing template and respond to the user by indicating an existing workflow template cannot be found. However, using methods described herein, agent flow generator generates a custom workflow. Agent flow generator also enables the user to select and preview the workflow. By selecting the template, the natural language prompt of the user can be converted into SQL or some other query language. Moreover, the agent flow generator may provide a built-in API call allowing, or in some cases, causing, an application to execute the workflow.

In some aspects, agent flow generator includes an advanced feature that enables a user who has a deep understanding of AI agent workflows to dynamically modify an existing workflow. This feature enables a user to engage in a chat conversation with the LLM and dynamically modify an existing flow. In this way, the agent flow generator allows real-time adjustments based on a user's requirements, providing full control over the structure of the flow.

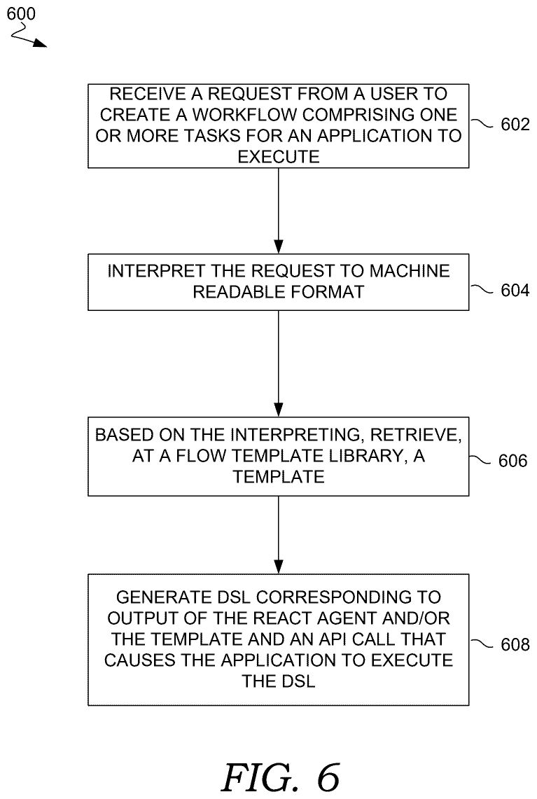

Referring now to FIG. 6, a flow diagram is provided that illustrates an example method 600 for utilizing an agent flow generator to create a workflow, in accordance with some implementations of the present disclosure. The method 600 can be performed, for instance, by the agent flow generator 104 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, a request from a user to create a workflow comprising one or more tasks for an application to execute is received at a prompt.

At block 604, the request is interpreted, at a large language model, to machine readable format. In some aspects, templates from a template library are ranked, according to match probability with the requested workflow.

At block 606, a template of the templates for the workflow is retrieved (if any matching templates are identified) at the flow template library. In some aspects, the template is selected based on the ranking.

At block 608, domain specific language (DSL) corresponding to output of the ReAct agent and/or the template and an application programming interface call that causes the application to execute the DSL is generated. In some aspects, a DSL file for the generated DSL corresponding to the output of the ReAct agent and/or template to the application is provided. The DSL file causes the application to execute the workflow.

In some aspects, the user may submit, at a second prompt, a second request from to modify the workflow. In some aspects, it may be determined the template is not a match for the workflow. Accordingly, the large language model interprets each task of the one or more tasks workflow to identify one or more templates for each task. A task template of the one or more templates for each task may be retrieved at the flow template library. The task template for each task may be combined or aggregated into a second template. Upon determining the second template is a match for the workflow, DSL corresponding to the second template may be generated.

Having described implementations of the present disclosure, an exemplary operating environment in which embodiments of the present technology can be implemented is described below in order to provide a general context for various aspects of the present disclosure. Referring initially to FIG. 7 in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should the computing device 700 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what can be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory can be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which can be built in. Illustrative components include a microphone, joystick, game pad, satellite dish, scanner, printer, wireless device, etc. The I/O components 720 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 can be equipped with depth cameras, such as, stereoscopic camera systems, infrared camera systems, RGB camera systems, and combinations of these for gesture detection and recognition. Additionally, the computing device 700 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving, at a prompt, a request from a user to create a workflow comprising one or more tasks for an application to execute;
interpreting, at a large language model, the request in machine readable format;
based on the interpreting, retrieving, at a flow template library, a template; and
generating domain specific language (DSL) corresponding to output of a ReAct agent and/or the template and an application programming interface call that causes the application to execute the DSL.

2. The one or more computer storage media of claim 1, further comprising providing a DSL file for the generated DSL to the application, the DSL file causing the application to execute the DSL.

3. The one or more computer storage media of claim 1, further comprising ranking one or more templates.

4. The one or more computer storage media of claim 3, further comprising automatically selecting, based on the ranking, the template from the one or more templates.

5. The one or more computer storage media of claim 1, further comprising receiving, at a second prompt, a second request from the user to modify the workflow.

6. The one or more computer storage media of claim 1, further comprising, upon determining the template is not a match for the workflow, interpreting, at the large language model, each task of the one or more tasks to identify one or more templates for each task.

7. The one or more computer storage media of claim 6, further comprising retrieving, at the flow template library, a task template of the one or more templates for each task.

8. The one or more computer storage media of claim 7, further comprising combining the task template for each task into a second template.

9. The one or more computer storage media of claim 8, further comprising, upon determining the second template is a match for the workflow, DSL corresponding to the second template.

10. A method of utilizing generative artificial intelligence to generate domain specific language (DSL) for a workflow of an application:
receiving, at a prompt, a request from a user to create a workflow comprising one or more tasks for an application to execute;
interpreting, at a large language model, the request in machine readable format;
based on the interpreting, retrieving, at a flow template library, a template; and
generating domain specific language (DSL) corresponding to output of a ReAct agent and/or the template and an application programming interface call that causes the application to execute the DSL.

11. The method of claim 10, further comprising providing a DSL file for the generated DSL, the DSL file causing the application to execute the DSL.

12. The method of claim 10, further comprising ranking one or more templates.

13. The method of claim 12, further comprising automatically selecting, based on the ranking, the template from the one or more templates.

14. The method of claim 10, further comprising receiving, at a second prompt, a second request from the user to modify the workflow.

15. The method of claim 10, further comprising, upon determining the template is not a match for the workflow, interpreting, at the large language model, each task of the one or more tasks to identify one or more templates for each task.

16. The method of claim 15, further comprising retrieving, at the flow template library, a task template of the one or more templates for each task.

17. The method of claim 16, further comprising combining the task template for each task into a second template.

18. The method of claim 17, further comprising, upon determining the second template is a match for the workflow, generating domain specific language (DSL) corresponding to the second template.

19. A computer system comprising:
a processor; and
a computer storage medium storing computer-useable instructions that, when used by the processor, causes the computer system to perform operations comprising:
receiving, at a prompt, a request from a user to create a workflow comprising one or more tasks for an application to execute;
interpreting, at a large language model, the request in machine readable format; and
based on the interpreting, retrieving, at a flow template library, a template;
and one of:
(1) upon determining the template is a match for the workflow, generating DSL corresponding to output of a ReAct agent and/or the template and an application programming interface call that causes the application to execute the DSL; or
(2) upon determining the template is not a match for the workflow, interpreting, at the large language model, each task of the one or more tasks workflow to identify one or more templates for each task.

20. The computer system of claim 19, wherein upon determining the template is not a match for the workflow, the operations further comprise:
retrieving, at the flow template library, a task template for each task. combining the task template for each task into a second template. upon determining the second template is a match for the workflow, generating domain specific language (DSL) corresponding to the output of the ReAct agent and/or the second template.
